(19) United States
(12) Patent Application Publication
(10) Pub. No.: US 2011/0267421 A1
(43) Pub. Date: Nov. 3, 2011

(54) Method and Apparatus for Two-Way Multimedia Communications

(75) Inventor: Edward L. Sutter, JR., Fanwood, NJ (US)

(73) Assignee: ALCATEL-LUCENT USA INC., Murray Hill, NJ (US)

(21) Appl. No.: 12/770,991

(22) Filed: Apr. 30, 2010

(51) Int. Cl. H04N 7/14

(52) U.S. Cl. 348/14.12; 348/E07.077

(57) ABSTRACT

A communication device comprises a two-way video system for transmitting video data from a first location to a second location, and displaying at the first location video data received from the second location. The device also comprises two microphones for generating two audio signals, and a processor configured to map the two audio signals respectively to two speakers used by an operator at the second location. The processor is further configured to move a portion of the device about an axis in response to control signals received from the second location.

### FIELD OF THE INVENTION

This specification relates generally to two-way multimedia communications, and more particularly to methods and apparatus for enabling an individual to participate in a meeting from a remote location.

### BACKGROUND

Modern telecommunications technologies enable people to conduct meetings without being physically present at the same location. It has become commonplace for individuals at different locations to use telephone conferencing and/or video communications technologies to conduct business meetings, conference calls, and other forms of interaction. However, existing communication systems used to conduct such meetings typically employ only a speakerphone and perhaps one or more computer-based audio/video platforms. Existing systems do not provide to those participating in such meetings a simulated experience of being in the presence of the other participants.

### SUMMARY OF THE INVENTION

In accordance with an embodiment of the invention, a communication device is provided that enables an individual to participate in a meeting from a remote location. The communication device comprises a two-way video system for transmitting video data from a first location to a second location, and displaying at the first location video data received from the second location. The device also comprises two microphones for generating two audio signals, and a processor configured to map the two audio signals respectively to two speakers used by an operator at the second location. The processor is further configured to move a portion of the device about an axis in response to control signals received from the second location.

The two-way video system may comprise a display device located on the communication device. The device further comprises a base portion configured to rotate about the axis in response to the control signals. The base portion comprises a first portion configured to rotate about a vertical axis and a second portion configured to rotate about a horizontal axis. The two microphones may be disposed in a manner to approximate a perception of sounds by a human.

The processor may be configured to map a first audio signal to a first transmission channel associated with a right side, and to map a second audio signal to a second transmission channel associated with a left side. The first and second transmission channels may be associated respectively with first and second speakers in headphones used by an operator at the second location. The control signals may be received from the second location via a network.

In another embodiment of the invention, a method for controlling a device disposed at a first location is provided. First video data is transmitted from a first location to a second location, and second video data received from the second location is displayed at the first location. Two audio signals are detected and mapped respectively to two speakers used by an operator at a second location. At least a portion of the device is moved about an axis in response to control signals received from the second location.

In another embodiment of the invention, a computer readable medium having program instructions stored thereon is provided. The instructions are capable of execution by a processor and define the steps of transmitting first video data from a first location to a second location, and displaying at the first location second video data received from the second location. The program instructions further define the steps of detecting two audio signals, and mapping the two audio signals respectively to two speakers used by an operator at a second location. The program instructions also define the steps of moving at least a portion of the device about an axis in response to control signals received from the second location.

### BRIEF DESCRIPTION OF THE DRAWINGS

FIG. 1 is an illustration of a surrogate head device, in accordance with an embodiment of the invention;

FIG. 2 shows an example of a communication system, in accordance with an embodiment of the invention;

FIG. 3 shows a conference room, in accordance with an embodiment of the invention;

FIG. 4 is a block diagram of components of a surrogate head device, in accordance with the embodiment of FIG. 1;

FIG. 5 shows a remote participant employing a remote control device, in accordance with an embodiment of the invention;

FIG. 6 is a block diagram of components of a remote control device, in accordance with an embodiment of the invention; and

FIG. 7 is a flowchart depicting a method for conducting two-way multimedia communications, in accordance with an embodiment of the invention.

### DETAILED DESCRIPTION

In accordance with an embodiment of the invention, a communication device (referred to herein as a “surrogate head device”) functions as a surrogate for an individual, enabling the individual to attend a meeting from a remote location. The surrogate head device is placed at a first location where a meeting is being conducted. The surrogate head device comprises a camera and microphones which capture images and sounds from the conference room; the images and sounds are transmitted to the remote location for viewing by the remote participant. The surrogate head device also comprises a display device which displays video images of the remote participant, and one or more speakers which convey voice signals received from the remote participant. Two-way communications are therefore conducted through the exchange of images and sounds between the first location and the remote participant.

The surrogate head device is supported by a support structure that allows the device to rotate to the right and to the left about a substantially vertical axis, enabling the viewing area of the camera to pan to the right or to the left, and to tilt up and down about a substantially horizontal axis, enabling the viewing area of the camera to pan up or down.

The remote participant utilizes a remote control device to control the surrogate head device. The remote control device may be linked to the surrogate head device via a network, such as the Internet. The remote control device includes a camera to capture video images of the remote participant, and one or more microphones to record his or her voice. The video images and voice signals are transmitted to the surrogate head device. The remote control device also comprises a display screen that enables the remote participant to view images of the meeting captured by the camera on the surrogate head device, and one or more audio speakers that enable the remote participant to hear voices and other sounds detected by the microphones on the surrogate head device. The audio speakers may be two speakers in a set of headphones worn by the remote participant, for example. The remote control device also includes one or more control devices, such as a computer mouse and/or a keypad, with which the remote participant controls the movement of the surrogate head device remotely. For example, the remote participant may cause the surrogate head device to rotate to the right or left, or to tilt up or down, by rolling a computer mouse to the right or to the left, or forward or backward. The remote participant's ability to rotate the surrogate head device to the right or left, or to tilt the device up and down, enables the remote participant to achieve and maintain eye contact with a person present at the meeting.

In one embodiment, the surrogate head device comprises two microphones situated in a manner to approximate the perception of sounds by a human. The sounds detected by the two microphones are mapped to two speakers used by the remote participant, generating for the remote participant a simulation of being present at the meeting. For example, when a person seated at the meeting to the right of the surrogate head device speaks, the sounds detected by the two microphones are mapped to the remote participant's two headphone speakers and cause the remote participant to perceive a voice coming from his or her right side.

The remote participant may control the movement of the surrogate head device based on the sounds generated by the two speakers in the headphones. For example, when the remote participant perceives a voice coming from his or her right side, the remote participant may cause the surrogate head device to rotate to the right in order to view the speaker at the meeting.

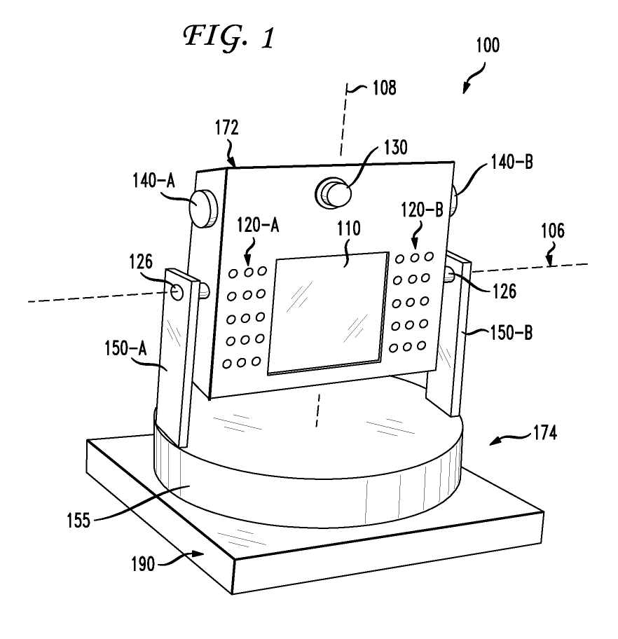

FIG. 1 is an illustration of a surrogate head device 100, in accordance with an embodiment of the invention. Surrogate head device 100 comprises a head portion 172 and a base portion 174. Head portion 172 comprises a display device 110, audio speakers 120-A and 120-B, a camera 130, and two microphones 140-A and 140-B. Surrogate head device 100 may comprise more or fewer than two microphones, any number of audio speakers, more than one camera, and more than one display device.

Base portion 174 supports head portion 172 and comprises a platform 190, a pan base 155, and a tilt base 150. In particular, head portion 172 is supported by tilt base 150, which comprises two vertical portions 150-A and 150-B disposed on pan base 155, and two horizontal support rods 126 attached to head portion 172. Support rods 126 define a horizontal axis 106 between vertical portions 150, and are configured to rotate about horizontal axis 106, causing head portion 172 to rotate about horizontal axis 106. Pan base 155 is disposed on platform 190 and is configured to rotate about a substantially vertical axis 108, causing head portion 172 to rotate about vertical axis 108. The capability of tilt base 150 and pan base 155 to rotate about two axes enables head portion 172 to rotate in order to face in a desired direction.

Display device 110 may comprise a liquid crystal display (“LCD”). In other embodiments, display device 110 may comprise another type of display device. Audio speakers 120-A and 120-B may comprise any type of audio device capable of reproducing voice signals and other sounds. Camera 130 may comprise any type of camera capable of capturing images and generating corresponding image data for transmission to a remote participant.

Microphones 140-A and 140-B may comprise any type of device capable of detecting sounds and generating corresponding audio signals for transmission to a remote participant. In one embodiment of the invention, two microphones 140-A and 140-B are situated on surrogate head device 100 at a distance that approximates the distance between the ears on a human's head, in order to receive audio signals in a manner substantially consistent with the reception of audio signals by a human's ears. Because microphones 140-A and 140-B are attached to head portion 172 of surrogate head device 100, the remote participant may maintain an accurate sense of audio direction because the microphones are always at the same position relative to camera 130. In other embodiments, surrogate head device 100 may be configured differently than as shown in FIG. 1. For example, surrogate head device 100 may comprise other components, and other mechanisms may be used to move all or portions of the device.

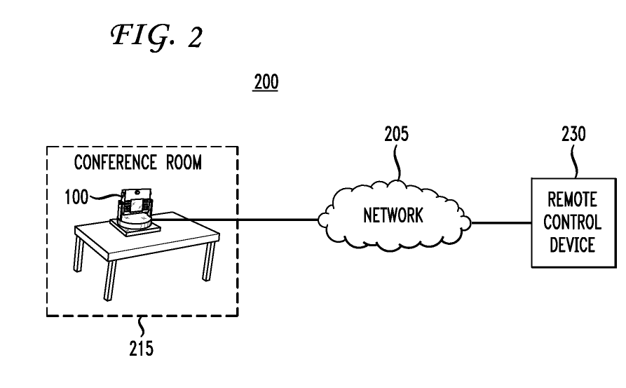

FIG. 2 illustrates a communication system 200 that enables an individual to participate in a meeting from a remote location, in accordance with an embodiment of the invention. Communication system 200 comprises surrogate head device 100 located in a conference room 215, a network 205, and a remote control device 230. Surrogate head device 100 is placed at a selected location within conference room 215, for example on a table among individuals who are present at the conference. Surrogate head device 100 and remote control device 230 are linked via network 205.

Network 205 may comprise one or more of a number of different types of networks, such as, for example, an intranet, a local area network (LAN), a wide area network (WAN), an internet, Fibre Channel-based storage area network (SAN) or Ethernet. Other networks may be used. Alternatively, network 205 may comprise a combination of different types of networks. In some embodiments, surrogate head device 100 may be linked to remote control device 230 via a direct connection.

Remote control device 230 is operated by an individual at a location remote from conference room 215. Remote control device 230 conveys, to the remote participant, audio and video signals received from surrogate head device 100, and transmits audio and video signals to surrogate head device 100. Remote control device 230 also transmits to surrogate head device 100 control signals received from the remote participant. In this manner, the remote participant may employ remote control device 230 to control surrogate head device 100 remotely.

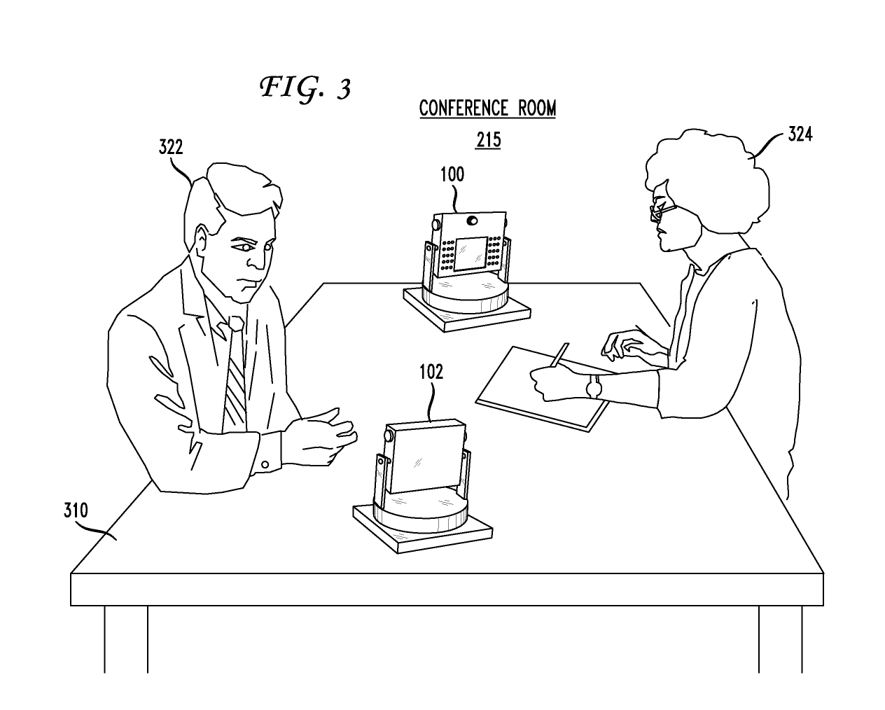

By selective placement within conference room 215, surrogate head device 100 may enable the remote participant to receive audio and video signals from conference room 215 in a manner that simulates the sensation of being physically present in conference room 215. FIG. 3 shows conference room 215, in accordance with an embodiment of the invention. In this example, a conference is being held around a table 310 located in conference room 215. Surrogate head device 100 is placed selectively on table 310. A second surrogate head device 102 is also placed selectively on table 310. Two individuals 322 and 324 are attending the conference in person, and two other individuals are participating remotely via surrogate head devices 100 and 102. By selective placement on table 310, surrogate head devices 100 and 102 enable their respective operators to control their devices to achieve and maintain eye-to-eye contact with persons 322 and 324, as desired. In addition, appropriate placement may also enable the operators of surrogate head devices 100 and 102 to maintain eye-to-eye contact with one another. Surrogate head devices 100 and 102 may also enable their respective operators to perceive audio signals, including voices, from the conference room, in a manner that simulates the sensation of being physically present in the conference room.

While the exemplary embodiment discussed herein describes a meeting held in a conference room, the systems, apparatus and methods described herein may be used to enable an individual to attend other types of meetings held in other places, from a remote location.

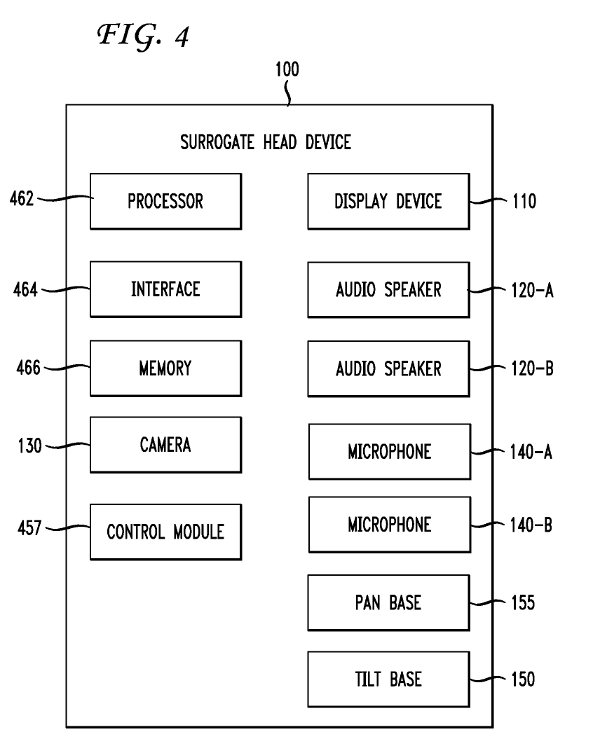

FIG. 4 is a block diagram of components of surrogate head device 100, in accordance with the embodiment of FIG. 1. Some of the components shown in FIG. 4 correspond to components shown in FIG. 1. For example, surrogate head device 100 comprises display device 110, audio speakers 120-A and 120-B, microphones 140-A and 140-B, camera 130, pan base 155, and tilt base 150.

Surrogate head device 100 also comprises a processor 462, an interface 464, and a memory 466. Processor 462 controls various operations of surrogate head device 100 by executing computer program instructions which define such operations. The computer program instructions may be stored in a non-transitory computer readable medium such as a random access memory (RAM), one or more disk drives, one or more optical disks, one or more tape drives, etc. Processor 462 may comprise hardware, software, or a combination of hardware and software. For example, in one embodiment, processor 462 comprises operating system software controlled by hardware, such as a central processing unit (CPU).

Interface 464 provides a communication gateway through which data may be transmitted between components of surrogate head device 100 and network 205. For example, interface 464 transmits to remote control device 230, via network 205, audio signals received by microphones 140-A and 140-B and video signals received by camera 130. Interface 464 receives audio signals and video signals from remote control device 230, via network 205, and transmits the audio and video signals to speakers 120-A and 120-B, and to display device 110, respectively. Interface 464 also receives control signals received from remote control device 230, and transmits the control signals to control module 457. In various embodiments, interface 464 may be implemented using a number of different mechanisms, such as one or more enterprise systems connection cards, modems, or network interfaces. Other types of interfaces may be used.

Memory 466 is accessed by processor 462 and/or other components of surrogate head device 100 to store various types of information. Memory 466 may comprise any one or more of a variety of different types of non-transitory computer readable media, such as random access memory (RAM), one or more disk drives, one or more optical disks, one or more tape drives, etc. Other types of memory devices may be used.

In one embodiment, pan base 155 may comprise one or more electromechanical components such as servos, motors, control circuitry, gears, etc., configured to enable pan base 155 to move in response to control signals. Pan base 155 may also comprise one or more microprocessors and memory devices to facilitate its operation. In other embodiments, other mechanisms may be used to control the movements of pan base 155.

In one embodiment, tilt base 150 may comprise one or more electromechanical components such as servos, motors, control circuitry, gears, etc., configured to enable tilt base 150 to move in response to control signals. Tilt base 150 may also comprise one or more microprocessors and memory devices to facilitate its operation. In other embodiments, other mechanisms may be used to control the movements of tilt base 150.

Surrogate head device 100 also comprises a control module 457. Control module 457 receives control signals from remote control device 230 (shown in FIG. 2), and controls the movement of pan base 155 and tilt base 150 in response to the control signals. For example, control module 457 may generate electrical signals and transmit such signals to servos and/or other components within pan base 155 and tilt base 150 in response to control signals received from remote control device 230. Control module 457 may also control functions of camera 130, display device 110, audio speakers 120-A and 120-B, and microphones 140-A and 140-B based on control signals received from remote control device 230.

Control module 457 may comprise a software program that includes multiple modules or subroutines providing respective services or functions, for example. In other embodiments, control module 457 may comprise multiple software programs. In alternative embodiments, control module 457 may comprise hardware, or a combination of hardware and software. Control module 457 may comprise a non-transitory computer readable medium, such as a magnetic disk, magnetic tape, or optical disk, that includes instructions in the form of computer code operable to perform various functions. In some embodiments, some or all of control module 457 may comprise instructions in the form of computer code that are stored in memory 466.

In other embodiments, surrogate head device 100 may comprise other components (software or hardware) in addition to those discussed herein.

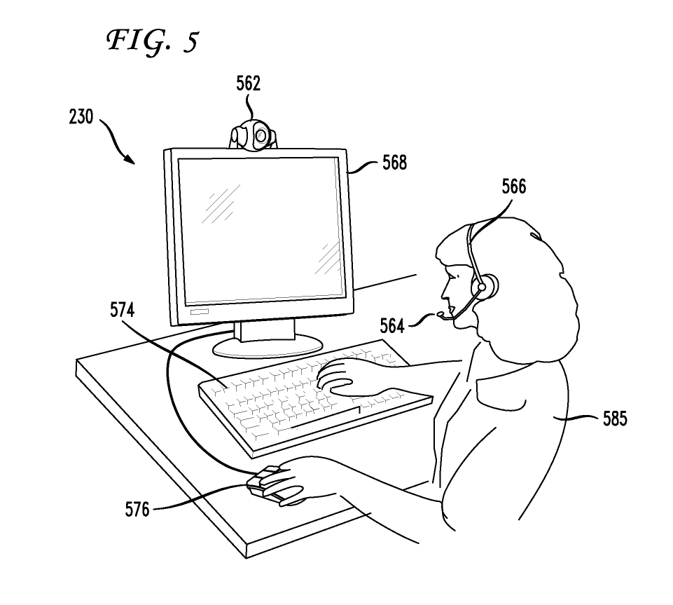

FIG. 5 shows a remote participant 585 employing a remote control device 230 to control a surrogate head device, in accordance with an embodiment of the invention. In this example, remote control device 230 comprises a personal computer. Remote control device 230 comprises a display screen 568, a camera 562, a keyboard 574, and a mouse device 576. Remote control device 230 also comprises speakers 566 and microphone 564. In this example, speakers 566 include two speakers in a set of headphones worn by remote participant 585. Alternatively, remote control device 230 may comprise another type of device capable of two-way communication with a surrogate head device, such as a laptop computer, a handheld computer, a cell phone, a laptop, a Blackberry, etc.

Referring again to FIG. 2, remote control device 230 is linked to surrogate head device 100 via network 205, enabling remote participant 585 to control surrogate head device 100 remotely. Remote participant 585 may use mouse device 576 and/or keyboard 574 to generate control signals for controlling the movement of surrogate head device 100. Mouse device 576 may be a computer mouse with two buttons and a scroll wheel, for example. Keyboard 574 may be a QWERTY keyboard. Other types of mouse devices and keyboards may be used, or other types of devices capable of generating control signals, such as a joystick, a touchpad, etc.

Display device 568 may comprise a liquid crystal display (“LCD”). In other embodiments, display device 568 may comprise another type of display device. Audio speakers 566 may comprise any type of audio device capable of reproducing voice signals and other audio signals that may be received from surrogate head device 100. Camera 562 may comprise any type of camera capable of capturing images and generating corresponding video data for transmission to surrogate head device 100. Microphone 564 may comprise any type of device capable of detecting sounds and generating corresponding audio data for transmission to surrogate head device 100.

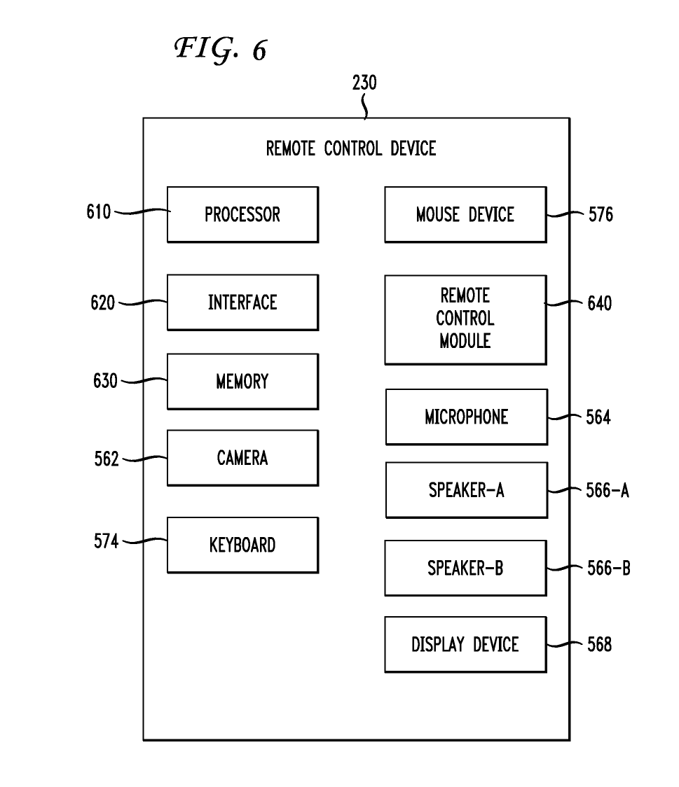

FIG. 6 is a block diagram of components of remote control device 230, in accordance with an embodiment of the invention. Some of the components of remote control device 230 shown in FIG. 6 correspond to components shown in FIG. 5. For example, remote control device 230 comprises display device 568, microphone 564, camera 562, mouse device 576, and keyboard 574. In this embodiment, speakers 566 comprise two speakers, including a right speaker 566-A and a left speaker 566-B, in a set of headphones.

Remote control device 230 also comprises a processor 610, an interface 620, and a memory 630. Processor 610 controls various operations of remote control device 230 by executing computer program instructions which define such operations. The computer program instructions may be stored in a non-transitory computer readable medium such as a random access memory (RAM), one or more disk drives, one or more optical disks, one or more tape drives, etc. Processor 610 may comprise hardware, software, or a combination of hardware and software. For example, in one embodiment, processor 610 comprises operating system software controlled by hardware, such as a central processing unit (CPU).

Interface 620 provides a communication gateway through which data may be transmitted between components of remote control device 230 and network 205. Interface 620 transmits to surrogate head device 100, via network 205, audio signals received by microphone 564 and video signals received by camera 562. Interface 620 receives audio signals and video signals from surrogate head device 100, via network 205, and transmits such signals to speakers 566 and to display device 568, respectively. Interface 620 receives control signals from remote control module 640 and transmits the control signals to surrogate head device 100. In some embodiments, interface 620 may receive control signals directly from mouse device 576 and from keyboard 574, and transmit the control signals to surrogate head device 100. In various embodiments, interface 620 may be implemented using a number of different mechanisms, such as one or more enterprise systems connection cards, modems, or network interfaces. Other types of interfaces may be used.

Memory 630 is accessed by processor 610 and/or other components of remote control device 230 to store various types of information. Memory 630 may comprise any one or more of a variety of different types of non-transitory computer readable media, such as random access memory (RAM), one or more disk drives, one or more optical disks, one or more tape drives, etc. Other types of memory devices may be used.

Remote control device 230 also comprises a remote control module 640. Remote control module 640 receives signals from mouse device 576 and from keyboard 574, and converts such signals into corresponding control signals for controlling surrogate head device 100. For example, movements of mouse device 576, or selections of keys on keyboard 574, may be detected and converted into appropriate control signals for controlling the movement of surrogate head device 100. Remote control module 640 transmits such control signals to surrogate head device 100 via interface 620. In another embodiment, a speech recognition system may be used to detect voice commands spoken by the remote participant, and generate corresponding control signals. In other embodiments, a gesture control system, and/or a facial recognition system may be used to detect facial movements and/or gestures made by the remote participant, and generate corresponding control signals.

Remote control module 640 may comprise a software program that includes multiple modules or subroutines providing respective services or functions, for example. In other embodiments, remote control module 640 may comprise multiple software programs. In alternative embodiments, remote control module 640 may comprise hardware, or a combination of hardware and software. Remote control module 640 may comprise a non-transitory computer readable medium, such as a magnetic disk, magnetic tape, or optical disk, that includes instructions in the form of computer code operable to perform various functions. In some embodiments, some or all of remote control module 640 may comprise instructions in the form of computer code that are stored in memory 630.

In other embodiments, remote control device 230 may comprise other components (software or hardware) in addition to those discussed herein.

In one embodiment, sounds detected by microphones 140-A and 140-B on surrogate head device 100 are selectively mapped to speakers 566-A and 566-B of remote control device 230, generating for remote participant 585 a simulation of being present in conference room 215. For example, when an individual seated in conference room 215 to the right of surrogate head device 100 speaks, the sounds detected by microphone 140-A are mapped to the remote participant's headphone speaker 566-A, and the sounds detected by microphone 140-B are mapped to the remote participant's headphone speaker 566-B, causing the remote participant to perceive a voice coming from his or her right side. In the exemplary embodiment, control module 457 (shown in FIG. 4) of surrogate head device 100 may perform processing to map the respective audio signals detected by microphones 140-A and 140-B to two “stereo” transmission channels associated with speakers 566-A and 566-B, respectively, prior to transmitting the signals to remote control device 230. For example, a first transmission channel A corresponding to “right” and a second transmission channel B corresponding to “left” may be used. The audio signals are received at remote control device 230 via the two transmission channels, and transmitted respectively to the corresponding speakers 566-A and 566-B. In other embodiments, the respective audio signals detected by microphones 140-A and 140-B may be mapped respectively to speakers 566-A and 566-B using other techniques, such as by using other types of channels, by coding, etc. In another embodiment, signals detected by microphones 140-A and 140-B are transmitted by surrogate head device 100 directly to remote control device 230, and remote control module 640 maps the audio signals to speakers 566-A and 556-B.

In some embodiments, including the embodiment described above, a remote participant operating remote control device 230 controls surrogate head device 100 to achieve and maintain eye contact with an individual in conference room 215. For example, appropriate rotation of surrogate head device 100 by a remote participant toward an individual who is speaking in conference room 215 may enable the remote operator and the speaker to see each other's faces and expressions in real-time, enabling eye-to eye contact to be achieved and maintained.

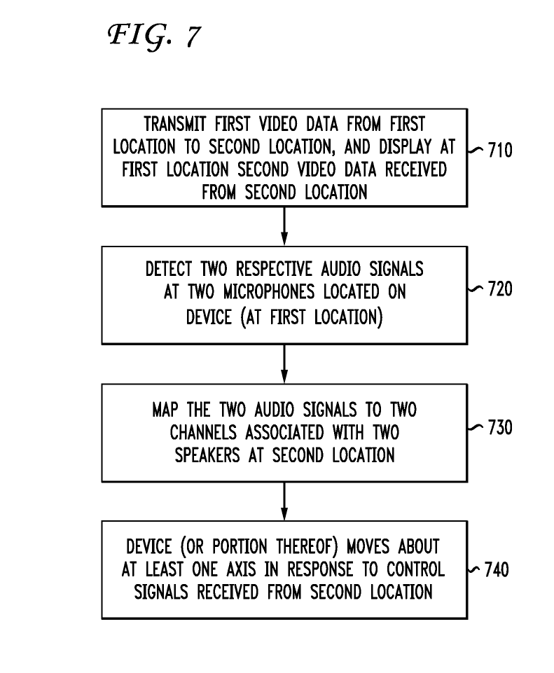

FIG. 7 is a flowchart depicting a method for conducting two-way audio and video communications, in accordance with an embodiment of the invention. At step 710, first video data is transmitted from a first location to a second location, and second video data received from the second location is displayed at the first location. In the exemplary embodiment, surrogate head device 100 transmits video data from conference room 215 to remote control device 230, and displays video data received from remote control device 230 to participants in conference room 215.

At step 720, two respective audio signals are detected at two microphones located on the device at the first location. As discussed above, surrogate head device 100 detects two audio signals at microphones 140-A and 140-B. The audio signals may contain voice signals, for example. At step 730, the two audio signals are mapped respectively to two channels associated with two speakers used by an operator at the second location. In the exemplary embodiment, surrogate head device 100 maps the two audio signals to two transmission channels (channels A and B, discussed above) and transmits the signals to remote control device 230. The two transmission channels are associated with two speakers in the remote operator's headphones 566.

At step 740, at least a portion of the device moves about at least one axis in response to control signals received from the operator at the second location. As discussed above, surrogate head device 100 receives control signals from remote control device 230, and in response, head portion 172 is rotated around a vertical axis by pan base 155 and/or about a horizontal axis by tilt base 150.

In some embodiments, the method steps described in FIG. 7 are defined by computer program instructions that are stored in memory 466 of surrogate head device 100 and executed by processor 462. In one example, control module 457 comprises computer program instructions implemented as computer executable code appropriately programmed by one skilled in the art to perform the algorithm defined by the method steps described in FIG. 7. By executing the computer program instructions, processor 462 executes the algorithm defined by the method steps of FIG. 7.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A communication device comprising:
a two-way video system for transmitting first video data from a first location to a second location, and displaying at the first location second video data received from the second location;
two microphones for generating two respective audio signals; and
at least one processor configured to:
map the two audio signals respectively to two speakers used by an operator at the second location; and
move at least a portion of the device about at least one axis in response to control signals received from the second location.

2. The communication device of claim 1, wherein the two-way video system comprises at least one display device.

3. The communication device of claim 1, further comprising at least one base portion configured to rotate about the at least one axis in response to the control signals.

4. The communication device of claim 3, wherein the at least one base portion comprises a first portion configured to rotate about a substantially vertical axis and a second portion configured to rotate about a substantially horizontal axis.

5. The communication device of claim 1, wherein the two microphones are disposed in a manner to approximate a perception of sounds by a human.

6. The communication device of claim 1, wherein the at least one processor is further configured to:
map a first one of the two audio signals to a first transmission channel associated with a right side; and
map a second one of the two audio signals to a second transmission channel associated with a left side.

7. The communication device of claim 6, wherein the first and second transmission channels are associated respectively with first and second speakers in headphones used by the operator at the second location.

8. The communication device of claim 1, wherein the control signals are received from the second location via a network.

9. A method for controlling a device disposed at a first location, the method comprising:
transmitting first video data from a first location to a second location;
displaying at the first location second video data received from the second location;
detecting two respective audio signals;
mapping the two audio signals respectively to two speakers used by an operator at a second location; and
moving at least a portion of the device about at least one axis in response to control signals received from the second location.

10. The method of claim 9, wherein the step of moving at least a portion of the device about at least one axis in response to control signals received from the second location further comprises:
rotating at least a first portion of the device about a substantially vertical axis; and
rotating at least a second portion of the device about a substantially horizontal axis.

11. The method of claim 9, wherein the step of mapping the two audio signals respectively to two speakers used by an operator at a second location further comprises:
mapping a first one of the two audio signals to a first transmission channel associated with a right side; and
mapping a second one of the two audio signals to a second transmission channel associated with a left side.

12. The method claim 11, wherein the first and second transmission channels are associated respectively with first and second speakers in headphones used by the operator at the second location.

13. The method of claim 9, further comprising:
receiving the control signals from the second location via a network.

14. A computer readable medium having program instructions stored thereon, the instructions capable of execution by a processor and defining the steps of:
transmitting first video data from a first location to a second location;
displaying at the first location second video data received from the second location;
detecting two respective audio signals;
mapping the two audio signals respectively to two speakers used by an operator at a second location; and
moving at least a portion of the device about at least one axis in response to control signals received from the second location.

15. The computer readable medium of claim 14, wherein the program instructions defining the step of moving at least a portion of the device about at least one axis in response to control signals received from the second location further comprises program instructions defining the steps of:
rotating at least a first portion of the device about a substantially vertical axis; and
rotating at least a second portion of the device about a substantially horizontal axis.

16. The computer readable medium of claim 14, wherein the program instructions defining the step of mapping the two audio signals respectively to two speakers used by an operator at a second location further comprises program instructions defining the steps of:
mapping a first one of the two audio signals to a first transmission channel associated with a right side; and
mapping a second one of the two audio signals to a second transmission channel associated with a left side.

17. The computer readable medium of claim 16, wherein the first and second transmission channels are associated respectively with first and second speakers in headphones used by the operator at the second location.

18. The computer readable medium of claim 14, wherein the program instructions further comprise program instructions defining the step of:
receiving the control signals from the second location via a network.
